(19) United States
(12) Patent Application Publication
(10) Pub. No.: US 2011/0141659 A1
(43) Pub. Date: Jun. 16, 2011

(54) MULTILAYER CERAMIC CAPACITOR

(75) Inventors: Dong Ik CHANG, Suwon (KR); Jin Hyung Lim, Hwaseong (KR); Ji Hun Jeong, Suwon (KR); Doo Young Kim, Yongin (KR)

(73) Assignee: SAMSUNG ELECTRO-MECHANICS CO., LTD.

(21) Appl. No.: 12/966,380

(22) Filed: Dec. 13, 2010

(30) Foreign Application Priority Data
Dec. 15, 2009 (KR) 10-2009-0125092

(51) Int. Cl. H01G 4/012

(52) U.S. Cl. 361/321.2

(57) ABSTRACT

There is provided a multilayer ceramic capacitor. The multilayer ceramic capacitor includes an effective layer including inner electrodes and dielectric layers that are alternately stacked, and a protection layer formed on each of top and bottom surfaces of the effective layer, the protection layer being formed by stacking dielectric layers. The effective layer has an outside part, an inside part and an outside part in that order along a stack direction, the inner electrodes of the outside parts have a smaller thickness than that of the inner electrodes of the inside part, and the outside parts have a thickness 0.1 to 0.5 times that of the protection layer.

### CROSS-REFERENCE TO RELATED APPLICATIONS

This application claims the priority of Korean Patent Application No. 10-2009-0125092 filed on Dec. 15, 2009, in the Korean Intellectual Property Office, the disclosure of which is incorporated herein by reference.

### BACKGROUND OF THE INVENTION

1. Field of the Invention

The present invention relates to a multilayer ceramic capacitor, and more particularly, to a multilayer ceramic capacitor capable of preventing a crack and a breakdown (i.e., dielectric break) due to thermal shock while stably securing capacitance.

2. Description of the Related Art

In general, a multilayer ceramic capacitor includes a plurality of ceramic dielectric sheets and inner electrodes inserted between the plurality of ceramic dielectric sheets. Because the multilayer ceramic capacitor can implement a high capacitance for its small size and can be easily mounted on a substrate, it is commonly used as a capacitive component for various electronic devices.

Recently, as electronic products (i.e., home appliances, etc.) have become more compact and multi-functional, chip components have also tended to become compact and highly functional. Following this trend, a multilayer ceramic capacitor is required to be smaller than ever before, but to have a high capacity, and at present, a multilayer ceramic capacitor having five hundred or more dielectric layers, each with a thickness of 2 um or less stacked therein, is being fabricated.

In this respect, however, because the ceramic dielectric layers are extremely thin and highly stacked, the volume ratio of inner electrode layers increases, causing a crack or a breakdown (i.e., dielectric break) in the ceramic laminated body due to thermal shock applied in the process of mounting them on a circuit board by firing, reflow soldering, and the like.

In detail, a crack is generated as stress caused by the difference of thermal expansion coefficients between a material forming the ceramic layers and a material forming the inner electrode layers acts on the ceramic laminated body, and in particular, both edges of upper and lower portions of the multilayer ceramic capacitor are mostly cracked.

In addition, stress is also generated at the uppermost and lowermost portions of the dielectric layers due to a thermal change, and in this case, when voltage is applied, a breakdown of the dielectric layers may be generated.

### SUMMARY OF THE INVENTION

An aspect of the present invention provides a multilayer ceramic capacitor capable of effectively preventing a crack and breakdown of a ceramic laminated body due to thermal shock while stably securing capacitance.

According to an aspect of the present invention, there is provided a multilayer ceramic capacitor including: an effective layer including inner electrodes and dielectric layers that are alternately stacked; and a protection layer formed on each of top and bottom surfaces of the effective layer, the protection layer being formed by stacking dielectric layers, wherein the effective layer has an outside part, an inside part and an outside part in that order along a stack direction, the inner electrodes of the outside parts have a smaller thickness than that of the inner electrodes of the inside part, and the outside parts have a thickness 0.1 to 0.5 times that of the protection layer.

The thickness of the inner electrodes of the outside parts may be 0.7 to 0.95 times than that of the inner electrodes of the inside part.

The dielectric layers of the effective layer may have a thickness of 5 um or less.

The number of dielectric layers stacked in the effective layer may be 100 or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating a multilayer ceramic capacitor according to an exemplary embodiment of the present invention;

FIG. 2 is a cross-sectional view taken along line A-A′ in FIG. 1; and

FIG. 3 is a cross-sectional view taken along line B-B′ in FIG. 1.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert the gist of the present invention, such explanation will be omitted but would be understood by those skilled in the art.

The same or equivalent elements are referred to as the same reference numerals throughout the specification.

It will be understood that when an element is referred to as being “connected with” another element, it can be directly connected with the other element or may be indirectly connected with the other element with element(s) interposed therebetween. Unless explicitly described to the contrary, the word “comprise” and variations such as “comprises” or “comprising,” will be understood to imply the inclusion of stated elements but not the exclusion of any other elements.

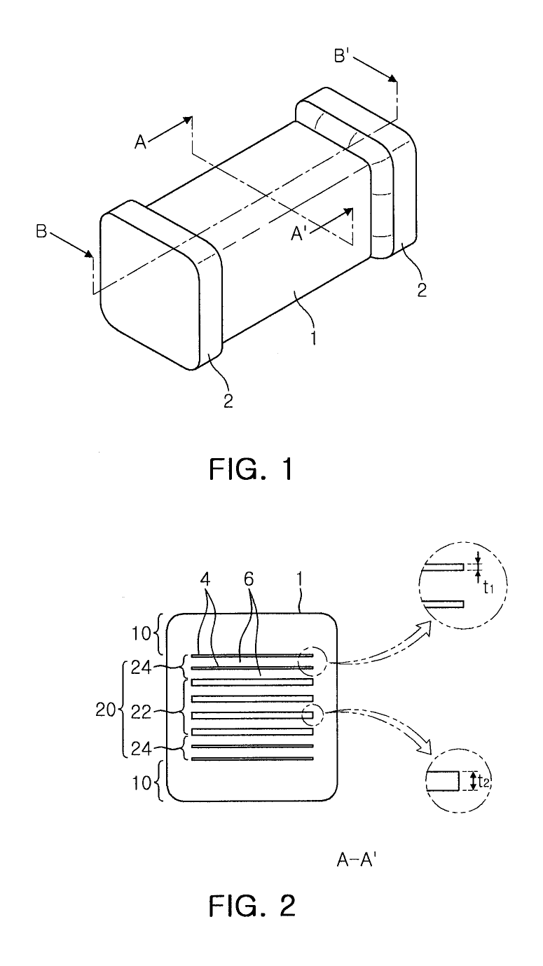

FIG. 1 is a perspective view illustrating a multilayer ceramic capacitor according to an exemplary embodiment of the present invention.

Referring to FIG. 1, the multilayer ceramic capacitor, according to this exemplary embodiment, may include a capacitor body 1 and outer electrodes 2.

The capacitor body 1 includes a plurality of dielectric layers stacked therein, and inner electrodes interleaved with the plurality of dielectric layers. Here, the dielectric layers may be formed of barium titanate (BaTiO₃), and the inner electrodes may be formed of nickel (Ni), tungsten (W), cobalt (Co), or the like.

The outer electrodes 2 may be formed on both side surfaces of the capacitor body 1. The outer electrodes 2 may serve as an external terminal by being electrically connected with the inner electrodes exposed to the outer surface of the capacitor body 1. In this case, the outer electrodes 2 may be formed using copper (Cu) or the like.

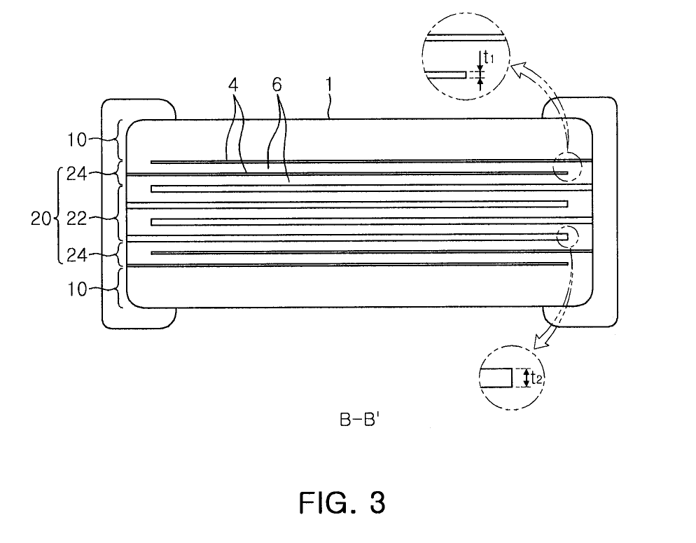

FIG. 2 is a cross-sectional view taken along line A-A′ in FIG. 1, and FIG. 3 is a cross-sectional view taken along line B-B in FIG. 1.

With reference to FIGS. 2 and 3, the multilayer ceramic capacitor, according to an exemplary embodiment of the present invention, may include an effective layer 20 formed by alternately stacking dielectric layers 6 and inner electrodes 4. Furthermore, the multilayer ceramic capacitor, according to this exemplary embodiment, may include protection layers 10 on the top and bottom surfaces of the effective layer 20, respectively. Here, the protection layer 10 is formed by stacking dielectric layers.

The effective layer 20 may have an outside part 24, an inside part 22 and an outside part 24 in that order along a direction in which the dielectric layers 6 are stacked (hereinafter also “stack direction”).

The protection layers 10 are respectively placed on the top and bottom surfaces of the effective layer 20, and are each formed by successively stacking a plurality of dielectric layers. Thus, the protection layers 10 can serve to protect the effective layer 20 from external shock.

When the inner electrodes 4 of the effective layer 20 are formed of nickel (Ni), the thermal expansion coefficient thereof is approximately 13×10⁻⁶/° C. The thermal expansion coefficient of the dielectric layers 6, formed of ceramics, is approximately 8×10⁻⁶/° C. This difference in thermal expansion coefficients between the dielectric layers 6 and the inner electrodes 4 results in stress acting on the dielectric layers 6 when thermal shock is applied thereto during a mounting process onto a circuit board using firing, reflow soldering or the like. The stress, created by the thermal shock, may cause cracks in the dielectric layers, or a breakdown thereof when voltage is applied thereto under this stress condition. Notably, a crack or a breakdown is likely to occur in the top and lower portions of the effective layer 20, that is, in the outside parts 24 thereof.

Therefore, in the multilayer ceramic capacitor, depicted in FIGS. 2 and 3 according to this exemplary embodiment, each inner electrode of the outside parts 24 of the effective layer 20 has a smaller thickness t₁ than the thickness t₂ of each inner electrode of the inside part 22 of the effective layer 20. Accordingly, cracks and breakdowns can be prevented from occurring.

However, the inner electrodes 4, when having a relatively small thickness, are very likely to include pores therein, and this may decrease the capacitance of the multilayer ceramic capacitor. Namely, the capacitance of the multilayer ceramic capacitor decreases as the thickness t₁ of each inner electrode of the outside parts 24 becomes smaller relative to the thickness t₂ of each inner electrode of the inside part 22. The capacitance of the multilayer ceramic capacitor also decreases as the overall thickness of each of the outside parts 24, having the thin inner electrodes 4, becomes greater.

Since it is also important to prevent a crack and a breakdown, caused by thermal shock, while securing sufficient capacitance, appropriate values may be determined through experiments regarding the ratios of the thickness t₁ of each inner electrode of the outside parts 24 to the thickness t₁ of each inner electrode of the inside part 22, and regarding the ratio of the overall thickness of each outside part 24 to the thickness of the protection layer 10.

TABLE 1

| | | Thickness | | Number of |
|---|---|---|---|---|
| | Thickness | ratio of | | cracks |
| | ratio of | outside part | | generated in |
| | inner | to | | thermal |
| | electrodes | protection | Capacitance | shock |
| Example | (t1/t2) | layer (Y/X) | (uF) | testing |
| 1 | 1.22 | 0.3 | 10.3 | 23/300 |
| 2 | 1.00 | 0.3 | 10.2 | 11/300 |
| 3 | 0.97 | 0.3 | 10.2 | 5/300 |
| 4 | 0.95 | 0.3 | 10.2 | 0/300 |
| 5 | 0.89 | 0.3 | 10.2 | 0/300 |
| 6 | 0.83 | 0.3 | 10.1 | 0/300 |
| 7 | 0.70 | 0.3 | 10.1 | 0/300 |
| 8 | 0.68 | 0.3 | 9.9 | 0/300 |
| 9 | 0.65 | 0.3 | 9.6 | 0/300 |

Table 1 shows the result of measuring the number of cracks and capacitance under thermal shock while varying the thickness ratio (t₁/t₂) of the inner electrodes of the multilayer ceramic capacitor. Here, the thickness ratio (Y/X where X denotes the thickness of the protection layer 10 in the stack direction, and Y denotes the thickness of the outside part 24 in the stack direction) of the outside part to the protection layer is fixed at 0.3.

Nickel (Ni) powder, having a particle size of 0.1 um to 0.2 um, was used as a conductive paste for forming the inner electrodes 4. The content of the nickel powder was 40% to 50%. The inner electrodes of the outside parts 24 of the multilayer ceramic capacitor were implemented to have a thickness t₁ of approximately 0.5 um to 0.9 um, and the inner electrodes of the inside part 22 were implemented to have a thickness t₂ of approximately 0.7 um to 0.8 um. For the thermal shock testing, the inner electrodes were dipped in a lead pot at 320° C. for two seconds.

With reference to Table 1, it is seen that the number of cracks generated is reduced in the examples in which the thickness ratio (t₁/t₂) of the inner electrodes is 0.95 or less, and the capacitance is reduced in the examples in which the thickness ratio (t₁/t₂) of the inner electrodes is less than 0.70.

Accordingly, it can be determined that the thickness ratio (t₁/t₂) of the inner electrodes needs to range from 0.70 to 0.95 in order to prevent crack generation while stably ensuring sufficient capacitance.

TABLE 2

| | | Thickness | | Number of |
|---|---|---|---|---|
| | Thickness | ratio of | | cracks |
| | ratio of | outside part | | generated in |
| | inner | to | | thermal |
| | electrodes | protection | Capacitance | shock |
| Example | (t₁/t₂) | layer (Y/X) | (uF) | testing |
| 1 | 0.95 | 0.095 | 10.2 | 2/300 |
| 2 | 0.95 | 0.1 | 10.2 | 0/300 |
| 3 | 0.95 | 0.3 | 10.2 | 0/300 |
| 4 | 0.95 | 0.4 | 10.1 | 0/300 |
| 5 | 0.95 | 0.5 | 10.0 | 0/300 |
| 6 | 0.95 | 0.6 | 9.8 | 0/300 |

Table 2 shows the result of measuring the number of cracks and capacitance under thermal shock while varying the thickness ratio (Y/X where X denotes the thickness of the protection layer 10 in the stack direction, and Y denotes the thickness of the outside part 24 in the stack direction) of the outside part to the protection layer of the multilayer ceramic capacitor. Here, the thickness ratio (t₁/t₂) of the inner electrodes was fixed at 0.95.

Nickel (Ni) powder, having a particle size of 0.1 um to 0.2 um, was used as a conductive paste for forming the inner electrodes 4. The content of the nickel powder was 40% to 50%. The inner electrodes of the outside parts 24 of the multilayer ceramic capacitor were implemented to have a thickness t₁ of approximately 0.5 um to 0.9 um, and the inner electrodes of the inside part 22 were implemented to have a thickness t₂ of approximately 0.7 um to 0.8 um. For the thermal shock testing, the inner electrodes were dipped in a lead pot at 320° C. for two seconds.

Referring to Table 2, it can be seen that, when the thickness ratio (Y/X) of the outside part to the protection layer is less than 0.1, the number of cracks generated is increased and breakdown voltage is lowered. Also, when the thickness ratio (Y/X) of the outside part to the protection layer exceeds 0.5, the capacitance is reduced.

Accordingly, it can be determined that the thickness ratio (Y/X) of the outside part to the protection layer needs to range from 0.1 to 0.5 in order to prevent crack generation while stably ensuring capacitance.

As set forth above, according to the multilayer ceramic capacitor according to exemplary embodiments of the invention, the inner electrodes in both the upper and lower parts of the effective layer, including the dielectric layers and the inner electrodes that are alternately stacked, have a smaller thickness than that of other inner electrodes of the effective layer located between its upper and lower parts. Accordingly, cracks and breakdowns, which may easily occur in the upper and lower parts of the effective layer, can be prevented.

In addition, by controlling the thickness of the inner parts of the effective layer including thin inner electrodes, breakdowns can be effectively prevented while stably ensuring capacitance.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor comprising:
an effective layer including inner electrodes and dielectric layers that are alternately stacked; and
a protection layer formed on each of top and bottom surfaces of the effective layer, the protection layer being formed by stacking dielectric layers,
wherein the effective layer has an outside part, an inside part and an outside part in that order along a stack direction,
the inner electrodes of the outside parts have a smaller thickness than that of the inner electrodes of the inside part, and
the outside parts have a thickness 0.1 to 0.5 times that of the protection layer.

2. The multilayer ceramic capacitor of claim 1, wherein the thickness of the inner electrodes of the outside parts is 0.7 to 0.95 times that of the inner electrodes of the inside part.

3. The multilayer ceramic capacitor of claim 1, wherein the dielectric layers of the effective layer have a thickness of 5 um or less.

4. The multilayer ceramic capacitor of claim 1, wherein the number of dielectric layers stacked in the effective layer is 100 or more.
